(19) United States
(12) Patent Application Publication
(10) Pub. No.: US 2011/0218840 A1
(43) Pub. Date: Sep. 8, 2011

(54) SYSTEM AND METHOD FOR EXHIBITION ORGANIZER MANAGEMENT

(76) Inventors: David Margalit, Modi'in (IL); Motti Kleinmann, Hod Hasharon (IL)

(21) Appl. No.: 13/042,546

(22) Filed: Mar. 8, 2011

Related U.S. Application Data
(60) Provisional application No. 61/311,409, filed on Mar. 8, 2010.

(51) Int. Cl. G06Q 10/00

(52) U.S. Cl. 705/7.35; 705/7.29

(57) ABSTRACT

There is provided, in accordance with an embodiment of the present invention, an apparatus, system, and method for enabling smart managing of an exhibition, the system including: multiple scan-able tags for multiple products in the exhibition; scanning devices adapted to scan data from the tags; a communications server for enabling collection and communication of scanned data; an exhibition server communicability coupled to the communications server, the exhibition server being coupled to communicably coupled to a system database; and a business intelligence server communicability coupled to the exhibition server, the exhibition server being communicably coupled to a business intelligence database, wherein the business intelligence server is adapted to generate business intelligence data and to communicate selected business intelligence data to a system user.

### CROSS REFERENCE TO RELATED APPLICATIONS

This application claims priority from, and the benefit of, U.S. Provisional Patent Application No. 61/311,409, filed 8 Mar. 2010, entitled “SYSTEM AND METHOD FOR EXHIBITION ORGANIZER MANAGEMENT”, which is incorporated in its entirety herein by reference.

### FIELD OF THE INVENTION

The present invention relates to methods and devices useful in managing exhibitions or shows. Specifically, embodiments of the present invention relate to systems, methods and apparatuses that provide ways to enhance functionality of exhibitions management.

### BACKGROUND OF THE INVENTION

A trade fair, trade show, trade exhibition or expo is typically an exhibition organized so that companies or organization in a specific industry can showcase and demonstrate their latest products, service, study activities of rivals and examine recent market trends and opportunities.

Trade fairs often involve a considerable marketing investment by participating companies, including costs for space rental, design and construction of trade show displays, telecommunications and networking, travel, accommodations, and promotional literature and items to give to attendees. It is in general important for a trade show manager to show potential vendors why their participation is beneficial and why the costs involved may be justified.

The trade show industry serves a staggeringly wide and varied audience. Many industries have their own types of show style. Trade show vendors, in general, may use their exhibitions, stands or booths to increase sales and reinforce market share; increase share of customers and get current customers to buy more; introduce new products; and position or reposition their organization, brand and/or products.

It would be highly advantageous to have a system that would be able to provide an enhanced model and method of managing shows, to enable show managers to more accurately provide show metrics and other show data to help show vendors understand expected benefit and exposure for shows in which they may participate.

### SUMMARY OF THE INVENTION

There is provided, in accordance with an embodiment of the present invention, an apparatus, system, and method for enabling smart managing of an exhibition, the system including: multiple scan-able tags for multiple products in the exhibition; scanning devices adapted to scan data from the tags; a communications server for enabling collection and communication of scanned data; an exhibition server communicability coupled to the communications server, the exhibition server being coupled to communicably coupled to a system database; and a business intelligence server communicability coupled to the exhibition server, the exhibition server being communicably coupled to a business intelligence database, wherein the business intelligence server is adapted to generate business intelligence data and to communicate selected business intelligence data to a system user.

In some embodiments, the business intelligence data includes user behavior data. In some embodiments the business intelligence data is used to generate exhibitor pricing data and/or exhibition booth pricing data.

In other embodiments, the system may include an internet server for enabling remote interaction with the exhibition server. In some case, the exhibition server includes a file with instructions to execute commands to enable show management intelligence data generation. In some embodiments the business intelligence server includes a file with instructions to execute commands to enable generation of the business intelligence data.

In further embodiments the business intelligence data is generated in real time. In still further embodiments the system database includes a memory having stored thereon show related data and/or business intelligence related data. In further embodiments the business intelligence server further includes a user dashboard, which is used to enable users to remotely interface with the system.

According to some embodiments, a method is provided for enabling smart exhibition management, including configuring a show management system to receive data from multiple scanning devices; processing the received data from the scanning devices, according to selected criteria, to derive relevant business intelligence data; and sending the derived business intelligence data to system users to facilitate show related decisions.

In some embodiments, the method may include running a set of instructions to generate meaningful business intelligence data based on data selected from show data, product data, user behavior, sales data and/other relevant data sources. In some embodiments the system runs a set of instructions to generate meaningful business intelligence data substantially in real time.

According to further embodiments, a trade show management system integrating business intelligence know-how is provided, including: multiple scan-able tags for multiple products in the trade show; scanning devices adapted to scan data from the tags;

an exhibition server communicably coupled to a business intelligence server, where the exhibition server is communicably coupled to a business intelligence database,
wherein the business intelligence server is adapted to generate exhibition related business intelligence data and to communicate selected business intelligence data to a system user.

In further embodiments, the business intelligence data is generated substantially in real time.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic block diagram of a system for enabling smart exhibition management, according to some embodiments; and

FIG. 2 is a flowchart illustrating a process for enabling smart exhibition management, according to some embodiments.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

The term “real time” may denote a system that responds to events or signals within a predictable time after their occurrence; specifically the response time must be within the maximum allowed. Real time may also denote a data-processing system in which a computer receives constantly changing data, and processes it sufficiently rapidly to be able to control the source of the data. Real time may also describe a level of computer responsiveness that a user senses as sufficiently immediate or that enables the computer to keep up with some external process. The term “real time” may further include hard real-time, immediate real-time, soft real-time or near real time, to describe substantially instantaneous responses, within the limits of data communications, network delays, bandwidth limitations etc.

The word “exhibition” as used herein may encompass fairs, trade shows, conferences, conventions, markets, shopping centers, events or other gatherings of prospective buyers and sellers, service providers, consumers etc. The word “exhibitor” as used herein may encompass traders, organizations, companies, governmental entities, sellers, service providers, publicizers, booths, stalls etc. The word “consumers” as used herein may encompass actual or potential associates, buyers, clients, visitors, traders or other interested parties. The word “buyers” may encompass consumers, visitors, potential partners, associates, clients, customers and other interested parties. The word “sellers” may encompass service providers, exhibitors, sales personnel and other parties involved in promotions, sales, marketing, and business development.

The term “business intelligence” (BI) as used herein may encompass computer-based techniques used in spotting, digging-out, and analyzing business data from a wide range of data or information sources relating to business related decisions, criteria, factors, decision making etc. For example, BI may include actions such as reporting, online analytical processing, analytics, data mining, business performance management, benchmarking, text mining, and predictive analytics on exhibition management data, exhibition user behavior data, exhibition supplier data etc.

In some embodiments, trade show user and/or exhibitor data may be processed, analyzed and filtered to enable intelligent show management, optionally using automation and/or real time user behavior data. In some embodiments such exhibition management systems and methods may be adapted to provide show managers with smart pricing facilitation, user and resource management, show planning strategies and more.

According to some embodiments, a vendor or exhibitor may register all relevant products, promotions, materials, objects or people etc. that they would like to introduce in an exhibition into an exhibition or system server, optionally via a remote of connected terminal or computing device. Each item registered may be identified according to the unique exhibitor ID. The exhibition server may generate data for product tags or labels that will be attached to the displayed products or materials etc., or to a catalog or other materials showing the product details. Each label may be configured to contain a unique ID of the product, and optionally other relevant data. The server may send the relevant label data to the system printer, which may print out scan-able labels for each relevant product or object etc. The exhibitor may attach or couple a label or tag to all relevant products or objects etc. In some embodiments the tags may contain product data, version data, production data, supplier data etc. The tag data may typically be scan-able or in some embodiments may be actively transmitted, for example via Rf, WiFi, Bluetooth, Zigbee or other wireless transmission means. Consumers, visitors or buyers may initially register themselves with the system, optionally via a remote or connected terminal or computing device. The consumers may enter into the system relevant data about themselves and/or their preferences. In some examples the user work data, experience data, demographic data etc, may be entered. The consumers may generally be given a wireless scanning device that is enabled to maintain user registered data and to scan labels/tags, and optionally update user registration data. When a consumer sees a product, person or item of interest, the user may use their wireless scanning device to scan the relevant label(s), whereby the wireless device will record all relevant labels and/or label data. The scanning devices may include a display (e.g., for displaying scanned data, messages, alerts or other suitable data, and optionally user registration data). The scanning devices may include a buzzer, LED, or other suitable alerting mechanism (for alerting the user to potential labels of interest or when matches are made). The scanning devices may send the scanned data to the exhibition server via a wireless link, or in some embodiments via a terminal. The exhibition server may process, handle and manage the system data.

The scanning devices may include a scanner mechanism for enabling RfID scanning, barcode scanning, infrared scanning, or other suitable scanning mechanisms or technologies. The data from the labels scanned may be entered into the wireless scanning device and subsequently transmitted to the exhibition server, either at a user defined time, server specified time, device specified time, or in real time. The server may receive the consumer data given upon user registration, and may receive the data from the consumer's scanning device.

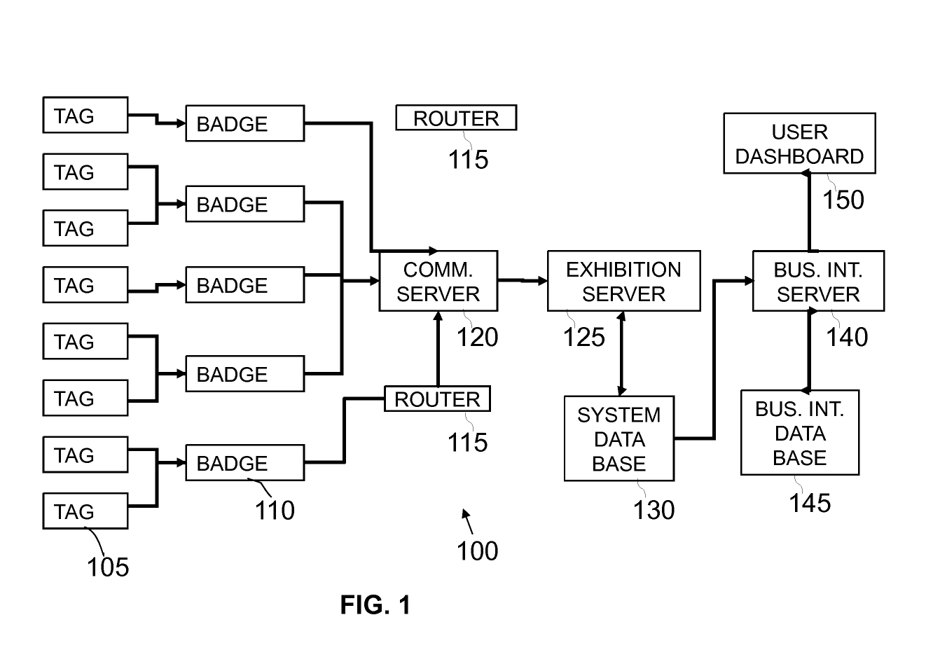

Reference is now made to FIG. 1 which is a schematic block diagram illustration of a system for enabling enhanced exhibition management, according to some embodiments. As can be seen in FIG. 1, the system 100 may include a server, for example a communications server 120 that includes a file(s) with instructions to execute commands to enable consolidating, aggregating, concentrating and/or filtering data from a multitude of remote scanning devices, such as badges 110, or other data sources. Communications server 120 also transmits the scanning or badge data to a system server, such as exhibition server 125. Badges 110 may include a data receiver (e.g., RFID, Barcode or other data scanners) for receiving data from multiple data tags 105 on scan-able targets, such as tags 105. Tags 105 may include data for transmitting (e.g., RFID based data) or data for scanning (e.g., bar code data) for products, suppliers, items, objects etc. The badges 110 may include a data transmitter (e.g., Zigbee, or any other proprietary or publicly available wireless technology) for transmitting scanned data to communications server 120. Exhibition server 125 incorporates file(s) with instructions to execute commands to enable running of business logic and other suitable codes, programs and applications to handle, process, filter and/or report on system data provided by system data base 130. System data base 130 may include user data, vendor data, product data, exhibition data, contact data, and scanned data from badges 110 etc. For example, system database may include user data, user identity data, registration data, product data, object data, media data, booth data, supplier data, and other relevant exhibition data, system data etc. In a further example, the system database 130 may include varied user data, exhibition management data, exhibitor data, geographical data, demographic data, payment data, purchasing data, facility usage data, historical data etc., from the user registration, supplier registration, booth activity, user activity etc.

System database 130 may be in communication with a Business Intelligence server 140. Business Intelligence server 140 may run business intelligence software or other suitable application or program code or software, to help query or request relevant data, reports, summaries, alerts etc. from exhibition server 125. Business Intelligence server 140 may include a file(s) with instructions to execute commands capable to collect, track, analyze, enrich, filter and/or report on data from System database 130. Business Intelligence server 140 may be coupled to Business Intelligence database 145, which may provide or store data related to business intelligence matters, such as exhibition management data, exhibition user behavior data, exhibition supplier data, user related data, vendor related data, product related data, exhibition related data, contact related data, and data related to the scanned data from badges 110 etc. The system 100 may further include a user interface, viewer or application, such as dashboard 150, being run on a remote terminal or a local terminal, which is in communication with business intelligence server 140. Dashboard 150 may enable a user, who may be using a wireless device, network device, remote computing device, optionally via the Internet, to run business intelligence queries, such as real time reports, analysis, statistical summaries, user reports, supplier reports, exhibit management data summaries, sales reports, payment reports, scanning reports etc.

In some embodiments system 100 may include a web server (not shown), connectable via the Internet (not shown), to allow a remote user to be in communication with the system. For example, a remote show organizer or other user may enter the system and run queries, generate reports and exhibition statistics from a remote computing device.

In some embodiments dashboard 150 enables an exhibition manager to read, use or otherwise handle real time or non-real time exhibition management data, for example to help determine problems, opportunities, user statistics, supplier statistics, showground usage statistics etc. System 100 may include a radio network for enabling communication of data between system components. For example, system 100 may further include communication routers 115 (e.g., Zigbee routers, or other suitable routers) to enable data transmission expansion or enhancement within the radio network.

According to some embodiments, the business intelligence (BI) server 140 may include programs, code or instructions to process user behavior data, exhibition data, sales data, business transaction data, user traffic data, supplier statistics or other relevant business intelligence or show related data, optionally in real time or substantially real time. The data may subsequently be used to map exhibition activities, exhibition sales, exhibition traffic, market or user trends, traffic hot spots, timing patterns, space utilization, space pricing, detailed buyer analysis, supplier analysis, etc. The data may be used to provide exhibitors, managers, users, workers, attendees and other relevant users, with real time information relevant to making exhibition planning and management decisions, including, for example, alerts, hints, recommendations, reports, statistics, estimates etc.

In some embodiments, an exhibit manager or organizer may use processed BI data to gather and generate show user and/or show exhibitor intelligence or data, to help determine booth price strategies, competitive pricing strategies, exhibitor management strategies, user preferences etc. For example, a show management system, in some embodiments, may monitor user actions for multiple users in an exhibition, and determine in substantially real time where the show hot spots, cold spots, congestion areas are etc. In further embodiments show data may be analyzed to predict exhibitor demand and supply, buyer demand, buyer demographic analysis, show participant interest data, analyze buyer demands, predict show trends, sales trends, food consumption requirements, and other relevant show or facility usage data. In some embodiments, buyer data may be matched to exhibitor products on a per product basis. For example, a user may be identified as having shown interest in a certain product type or model, and this data may be used to alert exhibitors or show organizers as to the presence of such users when in proximity with relevant products.

According to one example of a smart show organizer management implementation, a show organizer may be able to determine, substantially in real time, which demographic group or target group may be interested in product or service types. Such data may help show organizers, suppliers or exhibitors to implement highly targeted positioning, advertising campaigns, showroom designs etc. according to the generated BI data.

According to further embodiments, a trade show management system integrating business intelligence know-how is provided, including: multiple scan-able tags for multiple products in the trade show; scanning devices adapted to scan data from the tags;

an exhibition server communicably coupled to a business intelligence server, where the exhibition server is communicably coupled to a business intelligence database,
wherein the business intelligence server is adapted to generate exhibition related business intelligence data and to communicate selected business intelligence data to a system user. In further embodiments, the business intelligence data is generated substantially in real time.

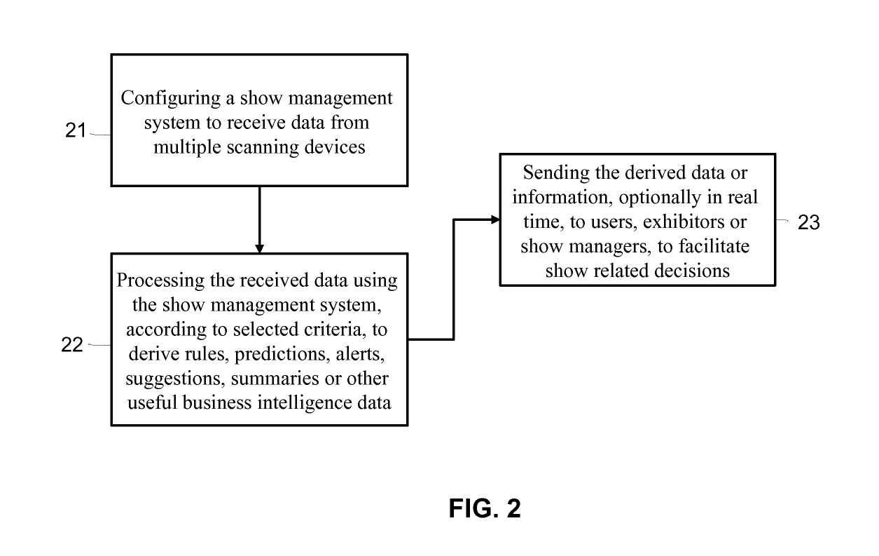

Reference is now made to FIG. 2, which schematically illustrates a series of operations or processes that may be implemented to facilitate smart exhibition management, according to some embodiments. As can be seen in FIG. 2, at block 21, a show management system may be configured to receive data from multiple scanning devices. At block 22, the show management system may process the received data, according to selected criteria, to derive rules, predictions, alerts, suggestions, summaries or other useful business intelligence data. For example, the system may run a program or set of instructions to generate meaningful business intelligence data, optionally in real time, based on show data, product data, user behavior, sales data and/or other relevant data sources. At block 23 the derived data or information may be sent, optionally in real time, to users, exhibitors or show managers to facilitate show related decisions, or to otherwise facilitate enhanced show management. Further, other steps or series of steps may be used.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A system for enabling smart managing of an exhibition, comprising:
multiple scan-able tags for multiple products in the exhibition;
scanning devices adapted to scan data from said tags;
a communications server for enabling collection and communication of scanned data;
an exhibition server communicably coupled to said communications server, said exhibition server being communicably coupled to a system database; and
a business intelligence server communicably coupled to said exhibition server, said exhibition server being communicably coupled to a business intelligence database, wherein said business intelligence server is adapted to generate business intelligence data and to communicate selected business intelligence data to a system user.

2. The system of claim 1, wherein said business intelligence data includes user behavior data.

3. The system of claim 1, wherein said business intelligence data is used to generate exhibitor pricing data.

4. The system of claim 1, wherein said business intelligence data is used to generate exhibition booth pricing data.

5. The system of claim 1, further comprising an internet server for enabling remote interaction with said exhibition server.

6. The system of claim 1, wherein said exhibition server includes a file with instructions to execute commands to enable show management intelligence data generation.

7. The system of claim 1, wherein said business intelligence server includes a file with instructions to execute commands to enable generation of said business intelligence data.

8. The system of claim 1, wherein said business intelligence data is generated in real time.

9. The system of claim 1, wherein said system database includes a memory having stored thereon show related data.

10. The system of claim 1, wherein said business intelligence database includes a memory having stored thereon business intelligence related data.

11. The system of claim 1, wherein said business intelligence server further includes a user dashboard, which is used to enable users to remotely interface with the system.

12. A method for enabling smart exhibition management, comprising:
configuring a show management system to receive data from multiple scanning devices;
processing the received data from said scanning devices, according to selected criteria, to derive relevant business intelligence data; and
sending the derived business intelligence data to system users to facilitate show related decisions.

13. The method of claim 12, comprising running a set of instructions to generate meaningful business intelligence data based on data selected from the set comprising show data, product data, user behavior, sales data and/other relevant data sources.

14. The method of claim 12, wherein said system runs a set of instructions to generate meaningful business intelligence data substantially in real time.

15. A trade show management system integrating business intelligence know-how, comprising:
multiple scan-able tags for multiple products in the trade show;
scanning devices adapted to scan data from said tags;
an exhibition server communicably coupled to a business intelligence server, said exhibition server being communicably coupled to a business intelligence database, wherein said business intelligence server is adapted to generate exhibition related business intelligence data and to communicate selected business intelligence data to a system user.

16. The system of claim 15, wherein said business intelligence data is generated substantially in real time.
